(19) United States
(12) Patent Application Publication
(10) Pub. No.: US 2026/0089413 A1
(43) Pub. Date: Mar. 26, 2026

(54) CONTROL SYSTEM, CONTROL APPARATUS, NETWORK APPARATUS, CONTROL METHOD AND PROGRAM

(71) Applicant: NTT, Inc., Tokyo (JP)

(72) Inventors: Hiroshi O, Musashino-shi (JP); Takahiro SUZUKI, Musashino-shi (JP); Tatsuya SHIMADA, Musashino-shi (JP); Naotaka SHIBATA, Musashino-shi (JP); Shin KANEKO, Musashino-shi (JP); Junichi KANI, Musashino-shi (JP)

(73) Assignee: NTT, Inc., Tokyo (JP)

(21) Appl. No.: 19/108,383

(22) PCT Filed: Sep. 15, 2022
(86) PCT No.: PCT/JP2022/034569

§ 371 Date: Mar. 3, 2025

(51) Int. Cl. H04Q 11/00; H04B 10/079; H04B 10/27

(52) U.S. Cl. CPC H04Q 11/0005; H04B 10/07955; H04B 10/27

(57) ABSTRACT

An aspect of the present invention is a control system required for optical communication, the control system including: a control unit that performs communication with a plurality of terminal devices using an optical signal, a control transceiver that performs conversion between an optical signal and an electrical signal, and a control optical switch that switches a connection destination of the control transceiver, in which the control unit switches the connection destination of the control transceiver by controlling an operation of the control optical switch, and the number of control optical switches is smaller than the number of terminal devices.

### TECHNICAL FIELD

The present invention relates to a control system, a control apparatus, a network apparatus, a control method, and a program.

### BACKGROUND ART

Optical communication technologies are becoming increasingly important.

### CITATION LIST

### Patent Literature

Patent Literature 1: WO 2021/131202 A

### SUMMARY OF INVENTION

### Technical Problem

In optical communication, since a plurality of users uses one network, it is necessary to distribute propagation destinations of optical signals. Therefore, in optical communication, a control system that controls distribution of propagation destinations of optical signals is used as a system required for optical communication.

The control system performs optical communication with a terminal device operated by the user and controls distribution. Since communication with the terminal device is optical communication, the control system includes a transceiver to communicate with each terminal device. More specifically, the control system includes an individual transceiver for each terminal device, thereby performing optical communication with each terminal device.

However, in a case where transceivers are provided as many as the number of terminal devices, it is necessary to add a transceiver each time the number of terminal devices increases, and the control system increases in size.

In view of the above circumstances, an object of the present invention is to provide a technique for suppressing an increase in size of a system required for optical communication.

### Solution to Problem

An aspect of the present invention is a control system required for optical communication, the control system including: a control unit that performs communication using an optical signal with a plurality of terminal devices that is external devices that transmit a control signal that is an optical signal for controlling an operation of the control system and a non-control signal that is an optical signal that is not the control signal; a multiplexing/demultiplexing device that is provided for each of the terminal devices and demultiplexes a signal in a band of the control signal and a signal in a band of the non-control signal; a control transceiver that is connected to any one of the multiplexing/demultiplexing devices and performs conversion between an optical signal and an electric signal; a control optical switch that switches the multiplexing/demultiplexing device that is a connection destination of the control transceiver; a distribution circuit that includes one or a plurality of input ports on which an optical signal is incident and one or a plurality of output ports from which the optical signal incident on the input port is output and is capable of changing a correspondence relationship between the input ports and the output ports; and a power monitor that measures a strength of the optical signal, in which the control signal is a signal transmitted and received between the terminal device and the control unit, and is a signal for one to control an other, the control transceiver converts the signal in the band of the control signal demultiplexed by the multiplexing/demultiplexing device that is a connection destination to an electric signal, the control unit executes processing of communicating with the terminal device based on information indicated by the electric signal, processing of acquiring propagation destination information indicating a propagation destination of a non-control signal, processing of controlling the distribution circuit so that a non-control signal propagates to the propagation destination indicated by the propagation destination information, and processing of switching a connection destination of the control transceiver by controlling an operation of the control optical switch based on a measurement result of the power monitor, and the number of the control optical switches is smaller than the number of the terminal devices.

An aspect of the present invention is a control device including: a control unit that performs communication using an optical signal with a plurality of terminal devices that is external devices that transmit a control signal that is an optical signal for controlling an operation of a control system required for optical communication and a non-control signal that is an optical signal that is not the control signal; and a control transceiver that is connected to any one of multiplexing/demultiplexing devices that are provided for each of the terminal devices and demultiplex a signal in a band of the control signal and a signal in a band of the non-control signal, and performs conversion between an optical signal and an electric signal, in which the control unit controls an operation of a network device including the multiplexing/demultiplexing device, a control optical switch that switches the multiplexing/demultiplexing device that is a connection destination of the control transceiver, a distribution circuit that includes one or a plurality of input ports on which an optical signal is incident and one or a plurality of output ports from which the optical signal incident on the input port is output and is capable of changing a correspondence relationship between the input ports and the output ports, and a power monitor that measures a strength of the optical signal, the control signal is a signal transmitted and received between the terminal device and the control unit, and is a signal for one to control an other, the control transceiver converts the signal in the band of the control signal demultiplexed by the multiplexing/demultiplexing device that is a connection destination to an electric signal, the control unit executes processing of communicating with the terminal device based on information indicated by the electric signal, processing of acquiring propagation destination information indicating a propagation destination of a non-control signal, processing of controlling the distribution circuit so that a non-control signal propagates to the propagation destination indicated by the propagation destination information, and processing of switching a connection destination of the control transceiver by controlling an operation of the control optical switch based on a measurement result of the power monitor, and the number of the control optical switches is smaller than the number of the terminal devices.

An aspect of the present invention is a network device including: a multiplexing/demultiplexing device that is provided for each of a plurality of terminal devices that is external devices that transmit a control signal that is an optical signal for controlling an operation of a control system required for optical communication and a non-control signal that is an optical signal that is not the control signal and demultiplexes a signal in a band of the control signal and a signal in a band of the non-control signal; a control optical switch that switches the multiplexing/demultiplexing device that is a connection destination of the control transceiver included in a control device including a control unit that performs communication using an optical signal with a plurality of the terminal devices and the control transceiver that is connected to any one of the multiplexing/demultiplexing devices and performs conversion between an optical signal and an electric signal; a distribution circuit that includes one or a plurality of input ports on which an optical signal is incident and one or a plurality of output ports from which the optical signal incident on the input port is output and is capable of changing a correspondence relationship between the input ports and the output ports; and a power monitor that measures a strength of the optical signal, in which the control signal is a signal transmitted and received between the terminal device and the control unit, and is a signal for one to control an other, the control transceiver converts the signal in the band of the control signal demultiplexed by the multiplexing/demultiplexing device that is a connection destination to an electric signal, the control unit executes processing of communicating with the terminal device based on information indicated by the electric signal, processing of acquiring propagation destination information indicating a propagation destination of a non-control signal, processing of controlling the distribution circuit so that a non-control signal propagates to the propagation destination indicated by the propagation destination information, and processing of switching a connection destination of the control transceiver by controlling an operation of the control optical switch based on a measurement result of the power monitor, and the number of the control optical switches is smaller than the number of the terminal devices.

An aspect of the present invention is a control method executed by a control system required for optical communication, the control system including: a control unit that performs communication using an optical signal with a plurality of terminal devices that is external devices that transmit a control signal that is an optical signal for controlling an operation of the control system and a non-control signal that is an optical signal that is not the control signal, a multiplexing/demultiplexing device that is provided for each of the terminal devices and demultiplexes a signal in a band of the control signal and a signal in a band of the non-control signal, a control transceiver that is connected to any one of the multiplexing/demultiplexing devices and performs conversion between an optical signal and an electric signal, a control optical switch that switches the multiplexing/demultiplexing device that is a connection destination of the control transceiver, a distribution circuit that includes one or a plurality of input ports on which an optical signal is incident and one or a plurality of output ports from which the optical signal incident on the input port is output and is capable of changing a correspondence relationship between the input ports and the output ports, and a power monitor that measures a strength of the optical signal, in which the control signal is processing of communicating with the terminal device based on information indicated by the electric signal and a signal transmitted and received between the terminal device and the control unit, and is a signal for one to control an other, the control transceiver converts the signal in the band of the control signal demultiplexed by the multiplexing/demultiplexing device that is a connection destination to an electric signal, and the number of the control optical switches is smaller than the number of the terminal devices, the control method including: by the control unit, processing of communicating with the terminal device based on information indicated by the electric signal, processing of acquiring propagation destination information indicating a propagation destination of a non-control signal, and a distribution destination control step of controlling the distribution circuit so that a non-control signal propagates to the propagation destination indicated by the propagation destination information; and by the control unit, a switching step of switching a connection destination of the control transceiver by controlling an operation of the control optical switch based on a measurement result of the power monitor.

An aspect of the present invention is a program for causing a computer to function as the control system described above.

### Advantageous Effects of Invention

According to the present invention, it is possible to suppress an increase in size of a system required for optical communication.

### BRIEF DESCRIPTION OF DRAWINGS

FIG. 1 is a diagram illustrating an example of a configuration of a control system of an embodiment.

FIG. 2 is a flowchart illustrating an example of a flow of processing executed in the control system according to the embodiment.

FIG. 3 is a diagram illustrating an example of a location of a multiplexing/demultiplexing device according to a modification.

FIG. 4 is a diagram illustrating an example of a storage unit that stores non-reception information according to the modification.

FIG. 5 is a diagram illustrating a first example of a configuration of a control system including a power monitor according to the modification.

FIG. 6 is a diagram illustrating a second example of a configuration of a control system including a power monitor according to the modification.

FIG. 7 is a diagram illustrating a third example of a configuration of a control system including a power monitor according to the modification.

FIG. 8 is a diagram illustrating a fourth example of a configuration of a control system including a power monitor according to the modification.

FIG. 9 is a flowchart illustrating an example of a flow of processing executed in each control system according to the modification.

### DESCRIPTION OF EMBODIMENTS

### Embodiment

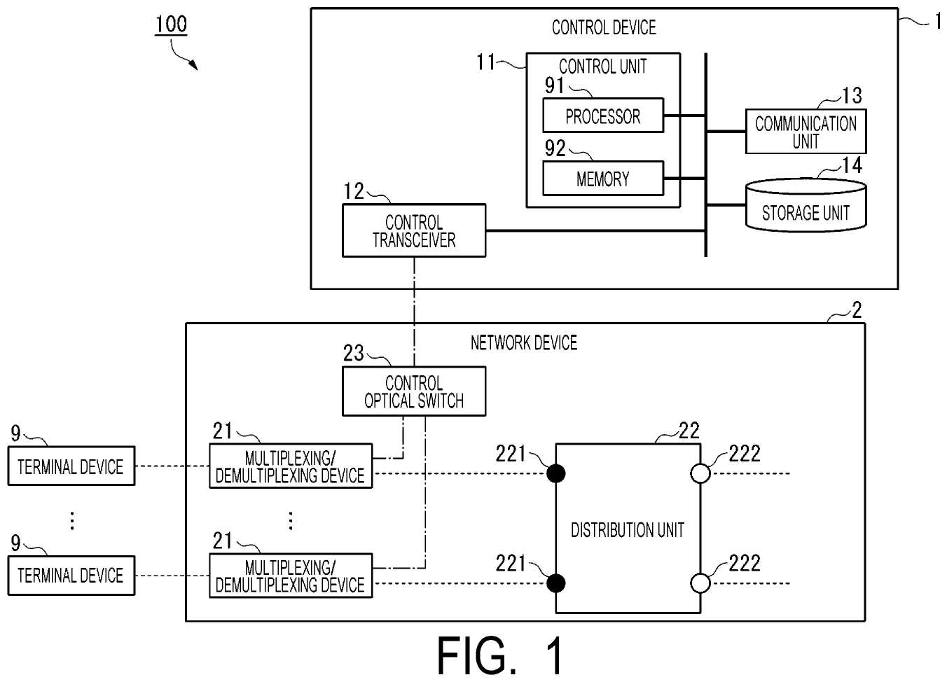

FIG. 1 is a diagram illustrating an example of a configuration of a control system 100 of an embodiment. Optical signals transmitted by a plurality of terminal devices 9 that is external devices transmitting optical signals propagate to the control system 100.

The terminal device 9 is, for example, an optical network unit (ONU) that transmits and receives optical signals under the control of a device operated by a user, such as a smartphone or a computer. Hereinafter, controlling the operation of the terminal device 9 such as an ONU by operating a device operable by a user, such as a smartphone or a computer, is expressed as operating the terminal device 9.

The optical signals propagated to the control system 100 are optical signals (hereinafter referred to as “control signals”) that control the operation of the control system 100 and optical signals (hereinafter, referred to as “non-control signals”) that are not control signals. The terminal device 9 may transmit the control signal and the non-control signal in a multiplexed state or at different timings.

The control signal is a signal transmitted and received between the terminal device 9 and a control unit 11 included in a control device 1 to be described below, and is a signal for one to control the other. The control signal includes information indicating a propagation destination of, for example, a non-control signal transmitted by the terminal device 9 that has transmitted the control signal after the timing at which the control signal is transmitted, the non-control signal being transmitted until a next control signal is transmitted from the terminal device 9 that has transmitted the control signal. Note that, in a case where the user who operates the terminal device 9 wants to send a message to a user who is a communication counterpart, the propagation destination is, for example, a terminal device operated by the communication counterpart. In addition, in such a case, the non-control signal is, for example, a signal indicating a message.

The band of the control signal and the band of the non-control signal may or may not overlap. Note that not overlapping means that the degree of overlap is equal to or less than a predetermined degree. The degree of overlap between the band of the control signal and the band of the non-control signal is, for example, equal to or less than a predetermined degree. The predetermined degree is, for example, a noise level.

The control system 100 propagates the propagated non-control signal to the propagation destination indicated by the propagation destination information that is information indicating the propagation destination of the non-control signal. The propagation destination information is carried by, for example, a control signal transmitted by the terminal device 9 that has transmitted the non-control signal, the control signal being the last control signal transmitted before the transmission of the non-control signal. Note that the last control signal transmitted before the transmission of the non-control signal is a control signal transmitted at the timing closest to the timing at which the non-control signal is transmitted among control signals transmitted before the transmission of the non-control signal. The propagation destination information may be information transmitted from an external device of the control system 100. The control system 100 is an example of a system required for optical communication.

The control system 100 includes a control device 1 and a network device 2. The control device 1 controls the operation of the network device 2.

The network device 2 is an optical circuit that operates under the control of the control device 1. Specifically, the optical signal propagated to the control system 100 is an optical signal propagated to the network device 2. The network device 2 propagates the propagated non-control signal to the propagation destination indicated by the propagation destination information. The propagation destination information is carried by, for example, the last control signal propagated before the non-control signal. Note that the last control signal transmitted before the non-control signal is a control signal propagated at the timing closest to the timing at which the non-control signal is transmitted among control signals transmitted before the transmission of the non-control signal.

A path between the terminal device 9 and the network device 2 is the same regardless of whether the propagating optical signal is a control signal or a non-control signal. Therefore, the optical signals reach the network device 2 in the order of transmission by the terminal devices 9.

The control device 1 includes the control unit 11 including a processor 91 such as a central processing unit (CPU) and a memory 92 connected via a bus and executes a program. The control device 1 functions as a device including the control unit 11, a control transceiver 12, a communication unit 13, and a storage unit 14 by executing a program.

More specifically, the processor 91 reads out the program stored in the storage unit 14 and stores the readout program in the memory 92. When the processor 91 executes the program stored in the memory 92, the control device 1 functions as a device including the control unit 11, the control transceiver 12, the communication unit 13, and the storage unit 14.

The control unit 11 controls the operations of the various functional units included in the control device 1. In addition, the control unit 11 controls the operation of the network device 2. For example, the control unit 11 controls the operation of the network device 2 so that the non-control signal propagates to the propagation destination indicated by the control signal.

The control unit 11 receives, for example, a control signal converted into an electric signal by the control transceiver 12. That is, the control unit 11 receives, for example, the electric signal indicating the propagation destination indicated by the control signal. For example, the control unit 11 controls the operation of the control transceiver 12 to transmit the information to the terminal device 9.

The control unit 11 may perform processing related to optical communication, the processing being processing with respect to the terminal device 9 by transmitting the information to the terminal device 9. The processing related to optical communication, the processing being processing with respect to the terminal device 9 is, for example, authentication with respect to the terminal device 9, setting of optical power with respect to the terminal device 9, setting of an error correction method with respect to the terminal device 9, and setting of a transmission/reception rate with respect to the terminal device 9.

The control transceiver 12 converts an optical signal and an electric signal. More specifically, the control transceiver 12 receives the control signal and converts the control signal into an electric signal. Accordingly, the electric signal after conversion by the control transceiver 12 indicates the propagation destination indicated by the control signal. The converted electric signal is received by the control unit 11. The control transceiver 12 transmits an optical signal to the terminal device 9 under the control of the control unit 11. As described above, the control transceiver 12 is a transceiver that converts an optical signal and an electric signal in communication between the control unit 11 and the terminal device 9.

The number of control transceivers 12 included in the control device 1 is smaller than the number of terminal devices 9. The control transceiver 12 may be any transceiver as long as it is a transceiver, and may be, for example, a transceiver that transmits and receives a control signal using an auxiliary management and control channel (AMCC).

The communication unit 13 is configured to include a communication interface for connecting the control device 1 to an external device. The communication unit 13 communicates with an external device in a wired or wireless manner. The external device is, for example, a terminal operated by an administrator of the control device 1. The communication unit 13 may be, for example, an external device that transmits the propagation destination information. In such a case, the communication unit 13 acquires the propagation destination information by communicating with an external device that transmits the propagation destination information.

The storage unit 14 is configured using a computer-readable storage medium device (non-transitory computer-readable recording medium) such as a magnetic hard disk device or a semiconductor storage device. The storage unit 14 stores various types of information regarding the control device 1. The storage unit 14 stores, for example, information input via the control transceiver 12 or the communication unit 13. The storage unit 14 stores, for example, various types of information generated by the operation of the control unit 11. The storage unit 14 may store information regarding the network device 2.

The storage unit 14 may store, for example, information (hereinafter referred to as “connection destination information”) indicating a connection destination of the control transceiver 12 to be described below. Although details will be described below, the connection destination of the control transceiver 12 is specifically a multiplexing/demultiplexing device 21, and the connection destination can be changed by a control optical switch 23. When the connection destination is changed, the information indicating the connection destination stored in the storage unit 14 is updated to, for example, information indicating a new connection destination. When the information indicating the connection destination stored in the storage unit 14 indicates the history of the connection destination and the connection destination is changed, for example, information indicating a new connection destination may be added to the information indicating the history of the connection destination.

In addition, the storage unit 14 may store information (hereinafter referred to as “correspondence relationship information”) indicating a correspondence relationship between an input port and an output port of a distribution unit 22. When the correspondence relationship between the input port and the output port is changed, the correspondence relationship information is also updated to indicate the changed correspondence relationship. In a case where the correspondence relationship information stored in the storage unit 14 indicates the history of the correspondence relationship between the input port and the output port of the distribution unit 22, for example, information indicating a new correspondence relationship may be added to the correspondence relationship information in accordance with a change in correspondence relationship.

The network device 2 includes the multiplexing/demultiplexing device 21, the distribution unit 22, and the control optical switch 23. The network device 2 includes the multiplexing/demultiplexing device 21 for each terminal device 9 that transmits an optical signal to the network device 2.

The multiplexing/demultiplexing device 21 demultiplexes the optical signal propagated from the terminal device 9 according to the frequency. The multiplexing/demultiplexing device 21 multiplexes a plurality of optical signals propagating to the terminal device 9. The multiplexing/demultiplexing device 21 is, for example, an optical coupler. The multiplexing/demultiplexing device 21 may be, for example, a frequency filter.

More specifically, the multiplexing/demultiplexing device 21 demultiplexes the signal in the band of the control signal and the signal in the band of the non-control signal. The multiplexing/demultiplexing device 21 is provided for each terminal device 9, and any one is connected to the control transceiver 12. Note that, specifically, the connection between the multiplexing/demultiplexing device 21 and the control transceiver 12 is connection via the control optical switch 23.

When the multiplexing/demultiplexing device 21 is connected to the control transceiver 12 via the control optical switch 23, the signal in the band of the control signal obtained by the multiplexing/demultiplexing device 21 is propagated to the control transceiver 12 via the control optical switch 23. The signal in the band of the non-control signal obtained by the multiplexing/demultiplexing device 21 is propagated to the distribution unit 22.

As described above, the signal in the band of the control signal demultiplexed by the multiplexing/demultiplexing device 21, which is a connection destination, propagates to the control transceiver 12. The control signal is included in the band of the control signal. Accordingly, the control transceiver 12 to which the signal in the band of the control signal propagates converts the control signal into an electric signal. The control unit 11 executes processing of communicating with the terminal device 9 on the basis of the information indicated by the electric signal.

The distribution unit 22 is an optical circuit including one or a plurality of input ports on which optical signals are incident and one or a plurality of output ports from which optical signals incident on the input ports are output, and capable of changing the correspondence relationship between the input ports and the output ports. Note that the correspondence relationship between the input ports and the output ports is a relationship between the input ports and the output ports as to the optical signal input to which input port is output to which output port.

Accordingly, the distribution unit 22 is, for example, an optical switch. The distribution unit 22 may be, for example, a reconfigurable optical add/drop multiplexer (ROADM) system.

The correspondence relationship between the input port and the output port of the distribution unit 22 is controlled according to the control by the control unit 11. The processing of control of the distribution unit 22 by the control unit 11 is processing of controlling the distribution unit 22 so that the non-control signal propagates to the propagation destination indicated by the propagation destination information. Such control is, for example, processing of controlling the distribution unit 22 so that the non-control signal propagates to the propagation destination indicated by the electric signal obtained by the control transceiver 12.

Hereinafter, the processing of controlling the distribution unit 22 so that the non-control signal propagates to the propagation destination indicated by the propagation destination information is referred to as distribution destination control processing. Specifically, the distribution destination control processing is processing of changing the correspondence relationship between the input port and the output port of the distribution unit 22. The propagation destination of the optical signal is changed by changing the correspondence relationship between the input port and the output port.

Note that the input port is a port through which an optical signal is incident on a target, and the output port is a port through which the optical signal incident on the input port is emitted from the target. The target is, for example, the distribution unit 22. The roles of the input port and the output port may change according to the propagation direction of the optical signal. For example, when the propagation direction of the optical signal is reversed, the input port may operate as the output port. In the example of FIG. 1, an input port 221 is an example of the input port, and an output port 222 is an example of the output port.

The control optical switch 23 is located between the control transceiver 12 and the multiplexing/demultiplexing device 21. Under the control of the control unit 11, the control optical switch 23 switches the multiplexing/demultiplexing device 21, which is a connection destination of the control transceiver 12. That is, the control unit 11 executes processing (hereinafter, referred to as “switching processing”) of switching the connection destination of the control transceiver 12 by controlling the operation of the control optical switch 23.

A connection destination candidate is any one of the multiplexing/demultiplexing devices 21 provided for the respective terminal devices 9. Accordingly, the control optical switch 23 switches the terminal device 9, which is a communication counterpart of the control unit 11.

For example, a control signal transmitted from the terminal device 9 is propagated to the control optical switch 23 via the multiplexing/demultiplexing device 21.

The control signal propagated to the control optical switch 23 via the multiplexing/demultiplexing device 21 connected to the control transceiver 12 is propagated to the control transceiver 12 via the control optical switch 23.

Note that the optical signal propagated from the multiplexing/demultiplexing device 21, which is not a connection destination of the control transceiver 12, to the control optical switch 23 does not propagate to the control transceiver 12. In addition, the optical signal transmitted by the control transceiver 12 does not propagate to the multiplexing/demultiplexing device 21, which is not a connection destination of the control transceiver 12.

In addition, the optical signal emitted from the control transceiver 12 under the control of the control unit 11 propagates to the multiplexing/demultiplexing device 21, which is a connection destination of the control transceiver 12, via the control optical switch 23.

Note that the switching processing is performed at a predetermined timing. The predetermined timing may be, for example, a periodic timing, or may be, for example, a timing according to a measurement result of a power monitor as in an example described below in a modification. Hereinafter, for simplicity of description, a case where the switching processing is periodically performed will be described as an example.

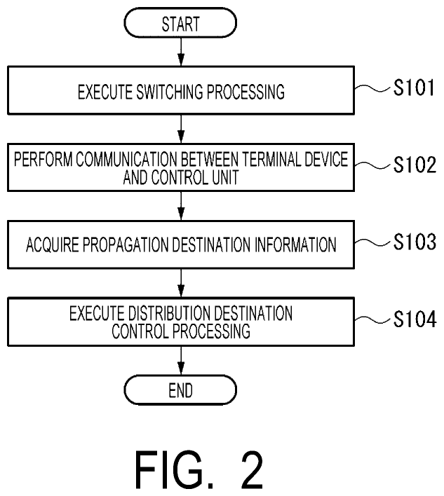

FIG. 2 is a flowchart illustrating an example of a flow of processing executed in the control system 100 according to the embodiment. The control unit 11 executes the switching processing (step S101). That is, the control unit 11 controls the operation of the control optical switch 23 to switch the terminal device 9, which is a communication counterpart. Next, the control unit 11 performs communication using an optical signal with the switched communication counterpart (step S102). In the communication in step S102, processing in which the control transceiver 12 converts a control signal into an electric signal and processing in which the control unit 11 communicates with the terminal device 9 on the basis of information indicated by the electric signal are executed. Next, the control unit 11 executes processing of acquiring propagation destination information (step S103). By executing the processing of step S103, the control unit 11 acquires propagation destination information. Next, the control unit 11 executes the distribution destination control processing on the basis of the acquired propagation destination information (step S104). That is, by controlling the distribution unit 22, the control unit 11 changes the correspondence relationship between the input port and the output port in the distribution unit 22 so that the non-control signal propagates to the propagation destination.

Note that regarding the acquisition of the propagation destination information by the control unit 11 in step S103, it may be acquired from an external device via the communication unit 13, for example, or in a case where the control signal carries the propagation destination information, the propagation destination information carried by the control signal transmitted by the terminal device 9, which is a communication counterpart, may be acquired.

The control system 100 configured as described above includes a smaller number of control transceivers 12 than the number of terminal devices 9 in communication with the terminal devices 9 using optical signals. Therefore, it is possible to suppress an increase in size of the device required for optical communication.

### <Regarding Effects Generated When Predetermined Degree is Noise Level>

Note that, since the signal in the band of the control signal is demultiplexed in the multiplexing/demultiplexing device 21, in a case where the above-described predetermined degree is larger than the noise level, an interference signal equal to or higher than the noise level remains in the band of the control signal of the non-control signal having passed through the multiplexing/demultiplexing device 21. This means a lack of information. On the other hand, when the predetermined degree is equal to or lower than the noise level, since there is no information in the signal equal to or lower than the noise level in the first place, a lack of information does not occur.

### Modification

Note that the multiplexing/demultiplexing device 21 may be located on the input port side of the distribution unit 22 as in the example of FIG. 1 or may be located on the output port side. A difference between a case where the multiplexing/demultiplexing device 21 is located on the input port side of the distribution unit 22 and a case where the multiplexing/demultiplexing device 21 is located on the output port side will be described by taking, as an example, a case where the optical signal continues to be incident on a specific input port and a case where the propagation destination indicated by the control signal is changed.

In a case where the optical signal continues to be incident on the specific input port and in a case where the propagation destination indicated by the control signal is changed, when the multiplexing/demultiplexing device 21 is located on the output port side of the distribution unit 22, the control optical switch 23 needs to switch the connection destination. On the other hand, when the multiplexing/demultiplexing device 21 is located on the input port side of the distribution unit 22, the control optical switch 23 does not need to switch the connection destination.

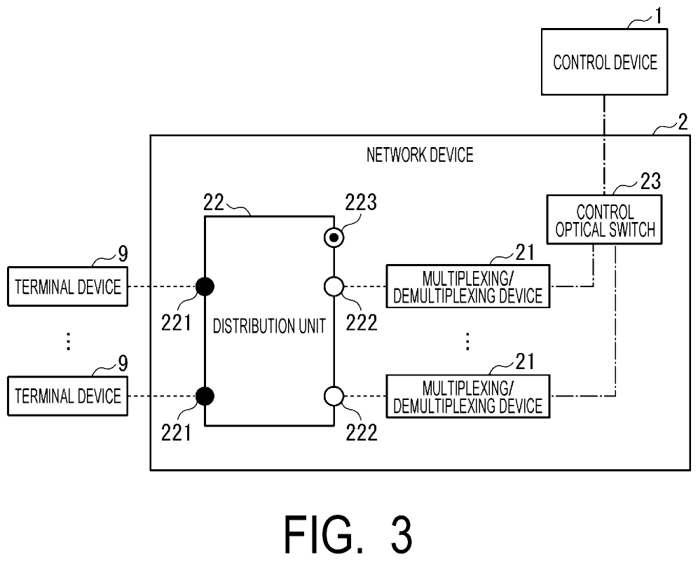

FIG. 3 is a diagram illustrating an example of a location of the multiplexing/demultiplexing device 21 according to the modification. In FIG. 3, the multiplexing/demultiplexing device 21 is located on the output port side of the distribution unit 22. In this example, the distribution unit 22 includes an initial connection port 223. The initial connection port 223 is a port for connection first when the distribution destination of the non-control signal in the terminal device is unknown. The control device grasps the propagation destination of the non-control signal in the terminal device via the initial connection port.

Note that the multiplexing/demultiplexing device 21 may not necessarily exist only on either the input port side or the output port side of the distribution unit 22, and some of the multiplexing/demultiplexing devices 21 may be located on the input port side and the rest may be located on the output port side.

Note that when receiving the optical signal in the band of the control signal, the control transceiver 12 may return a signal (hereinafter referred to as a “response signal”) indicating that the signal in the band of the control signal has been received. The processing of returning the response signal is performed under the control of the control unit 11. When the control transceiver 12 and the multiplexing/demultiplexing device 21 are not connected, no signal flows from the control transceiver 12 to the multiplexing/demultiplexing device 21. Accordingly, the response signal propagates toward the multiplexing/demultiplexing device 21 through which the optical signal received by the control transceiver 12 has passed. The response signal passes through the multiplexing/demultiplexing device 21 and propagates to the terminal device 9, which is a transmission source of the optical signal received by the control transceiver 12.

Meanwhile, the control signal transmitted from the terminal device 9 connected to the multiplexing/demultiplexing device 21 not connected to the control transceiver 12 is not received by the control transceiver 12. Accordingly, in a case where an event occurs in which a response signal is not returned even after a predetermined time has elapsed since the transmission of the optical signal, the event is information indicating that the terminal device 9 is in a state of not being the connection destination of the control transceiver 12. In such a case, when a response signal is not returned even after a predetermined time has elapsed since the transmission of the optical signal, the terminal device 9 may store information (hereinafter referred to as “non-reception information”) indicated by the optical signal transmitted but not received by the control transceiver 12 in a predetermined storage unit.

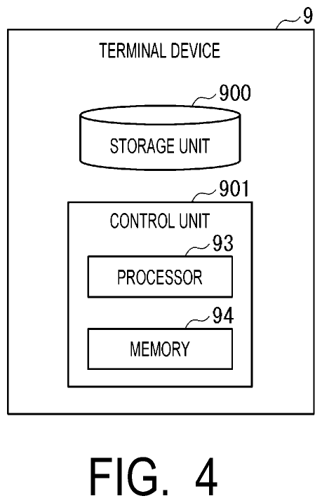

FIG. 4 is a diagram illustrating an example of the storage unit that stores non-reception information according to the modification. FIG. 4 illustrates an example of the terminal device 9 including a storage unit 900 and a control unit 901. The storage unit 900 is configured using a computer-readable storage medium device (non-transitory computer-readable recording medium) such as a magnetic hard disk device or a semiconductor storage device. The storage unit 900 is an example of the predetermined storage unit that stores non-reception information. The control unit 901 includes the processor 91 such as a central processing unit (CPU) and the memory 92 connected via a bus. The control unit 901 executes a program. The terminal device 9 functions as a device including the control unit 901 and the storage unit 900 by executing the program.

When the non-reception information is stored in the predetermined storage device as described above, the control unit 11 may access the predetermined storage device storing the non-reception information at a predetermined timing such as periodically and switch the connection destination of the control transceiver 12 to a connection destination according to the amount of the non-reception information. For example, the control unit 11 may control the control optical switch 23 to switch the connection destination of the control transceiver 12 to the multiplexing/demultiplexing device 21 connected to the terminal device 9 having a large amount of non-reception information. Note that access by the control unit 11 to the predetermined storage device storing the non-reception information may be performed by any method as long as it is an accessible method, and is performed via the communication unit 13, for example.

Note that the optical signal in the band of the non-control signal demultiplexed by the multiplexing/demultiplexing device 21 propagates to the distribution unit 22 regardless of whether the multiplexing/demultiplexing device 21 is connected to the control transceiver 12.

### <Another Example of Timing at Which Switching Processing is Performed>

The control system 100 may include a power monitor that measures the strength of the optical signal, and the control unit 11 may perform switching processing based on a result of measurement by the power monitor.

### First Example of Control System Including Power Monitor and Performing Switching Processing Based on Result of Measurement of Power Monitor

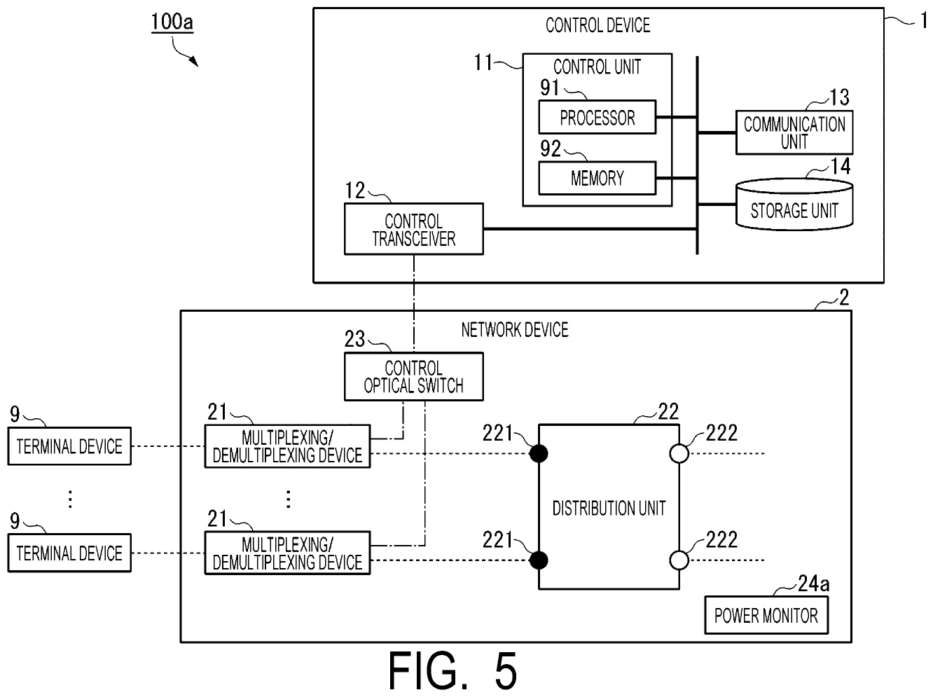

FIG. 5 is a diagram illustrating a first example of a configuration of the control system 100 including a power monitor according to the modification. FIG. 5 illustrates a control system 100a as an example of the control system 100 including a power monitor according to the modification.

The control system 100a is different from the control system 100 in including a power monitor 24a. The power monitor 24a measures the strength of the signal in the band of the non-control signal in each path regarding a path for propagation of the optical signal having passed through at least the multiplexing/demultiplexing device 21 that is not a connection destination of the control transceiver 12 among paths through which the optical signal in the band of the non-control signal propagates.

Hereinafter, among the paths through which the optical signal in the band of the non-control signal propagates, the path for propagation of the optical signal having passed through at least the multiplexing/demultiplexing device 21 that is not a connection destination of the control transceiver 12 is referred to as a first measured path.

The power monitor 24a may measure the strength at any location as long as the strength of the signal in the band of the non-control signal in each path, which is the first measured path, can be measured. For example, the power monitor 24a may measure the strength of the optical signal at the output port of the distribution unit 22. For example, the power monitor 24a may measure the strength of the optical signal at a location between the input port and the output port of the distribution unit 22.

The power monitor 24a transmits the measurement result to the control unit 11. The measurement by the power monitor 24a is performed at a predetermined timing such as periodically. Specifically, the measurement result is information indicating the measured strength in each path.

The control unit 11 that has received the measurement result determines whether there is a path (hereinafter referred to as a “first target path”) the strength of which indicated by the measurement result of the power monitor 24a is equal to or higher than a predetermined strength. Here, the predetermined strength is a strength with which the control unit 11 can determine whether the power monitor 24a has measured the strength of the non-control signal. When there is a first target path, the control unit 11 executes switching processing of switching the connection destination of the control transceiver 12 to the multiplexing/demultiplexing device 21 through which the non-control signal propagating through the first target path has passed.

As described above, in the control system 100a, the control unit 11 executes the switching processing of switching the connection destination of the control transceiver 12 by controlling the operation of the control optical switch 23 on the basis of the measurement result of the power monitor 24a.

Note that the power monitor 24a includes, for example, a probe including a power splitter, and measures the strength by separating a part of the optical signal propagating on the path using the power splitter and receiving the separated signal.

In addition, the power monitor 24a may include a light-receiving unit for each measurement target path and measure the strength in each path, or may include one light-receiving unit and periodically change the location of the probe to sequentially measure the strength in each path.

To be sure, an example of determination of a path (that is, a candidate for the first target path) through which the optical signal having passed through the multiplexing/demultiplexing device 21 that is not a connection destination of the control transceiver 12 propagates will be described. The determination of the candidate for the first target path is performed by the control unit 11 on the basis of the connection destination information or the correspondence relationship information, for example. A path other than the path connected to the connection destination indicated by the connection destination information is a candidate for the first target path.

<<Regarding Effects Achieved by Including Power Monitor 24a>>

In general, the terminal device 9 does not stop the transmission only once transmitting the non-control signal, but then transmits the non-control signal many times in succession. Therefore, when the control unit 11 determines that the path is the first target path, it means that the non-control signal has propagated to the first target path, and therefore, there is a high possibility that the non-control signal is transmitted to the first target path thereafter.

Accordingly, it is desirable from the viewpoint of communication efficiency that the control unit 11 starts communication with the terminal device 9 that is the transmission source of the non-control signal propagated through the first target path. This is because when the terminal device 9 that transmits the non-control signal and the control unit 11 perform communication and the propagation destination of the non-control signal is not controlled, communication with many erroneous transmissions occurs.

Switching of the connection destination of the control transceiver 12 may be performed, for example, by a method that is performed periodically without using the power monitor 24a, but in this case, it may take time to find the terminal device 9 that transmits the non-control signal. On the other hand, when the power monitor 24a is used, the multiplexing/demultiplexing device 21 connected to the terminal device 9 that transmits the non-control signal can be a connection destination of the control transceiver 12 without setting the multiplexing/demultiplexing device 21 connected to the terminal device 9 that does not transmit the non-control signal to be a connection destination.

Therefore, since the control system 100a of the modification configured as described above includes the power monitor 24a, the communication efficiency can be enhanced.

### Second Example of Control System Including Power Monitor and Performing Switching Processing Based on Result of Measurement of Power Monitor

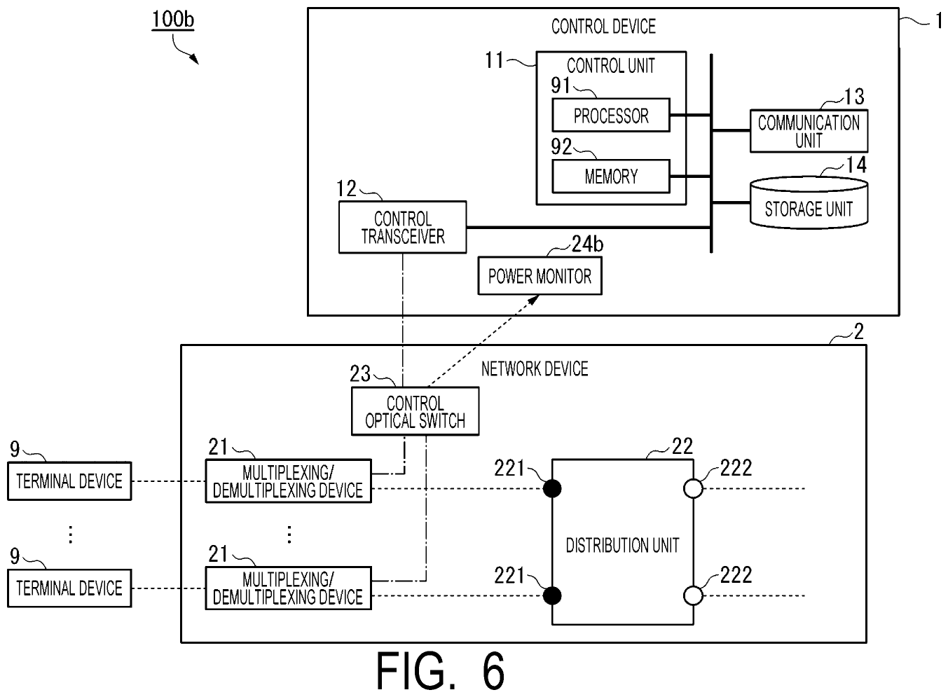

FIG. 6 is a diagram illustrating a second example of a configuration of the control system 100 including a power monitor according to the modification. FIG. 6 illustrates a control system 100b as an example of the control system 100 including a power monitor according to the modification.

The control system 100b is different from the control system 100 in including a power monitor 24b. The power monitor 24b measures the strength of the optical signal in the band of the control signal that has passed through the control optical switch 23.

In the control system 100b, the control unit 11 periodically changes the connection destination of the control transceiver 12.

The power monitor 24b transmits the measurement result to the control unit 11. The measurement by the power monitor 24b is performed at a predetermined timing such as periodically. Specifically, the measurement result is information indicating the measured strength.

The control unit 11 that has received the measurement result determines whether the strength indicated by the measurement result of the power monitor 24b is equal to or higher than the predetermined strength. Here, the predetermined strength is a strength with which the control unit 11 can determine whether the power monitor 24b has measured the strength of the control signal. In a case where the strength is equal to or higher than the predetermined strength, the control unit 11 executes the switching processing so that the multiplexing/demultiplexing device 21 through which the control signal has passed becomes a connection destination of the control transceiver 12.

As described above, in the control system 100b, the control unit 11 executes the switching processing of switching the connection destination of the control transceiver 12 by controlling the operation of the control optical switch 23 on the basis of the measurement result of the power monitor 24b.

### <Regarding Effects to be Achieved>

Since the control transceiver is connected only to a target the strength of which indicated by the measurement result of the power monitor is equal to or higher than the predetermined strength, the connection of the control transceiver to an unnecessary target can be reduced, and as a result, the control signal can be efficiently communicated.

### Third Example of Control System Including Power Monitor and Performing Switching Processing Based on Result of Measurement of Power Monitor

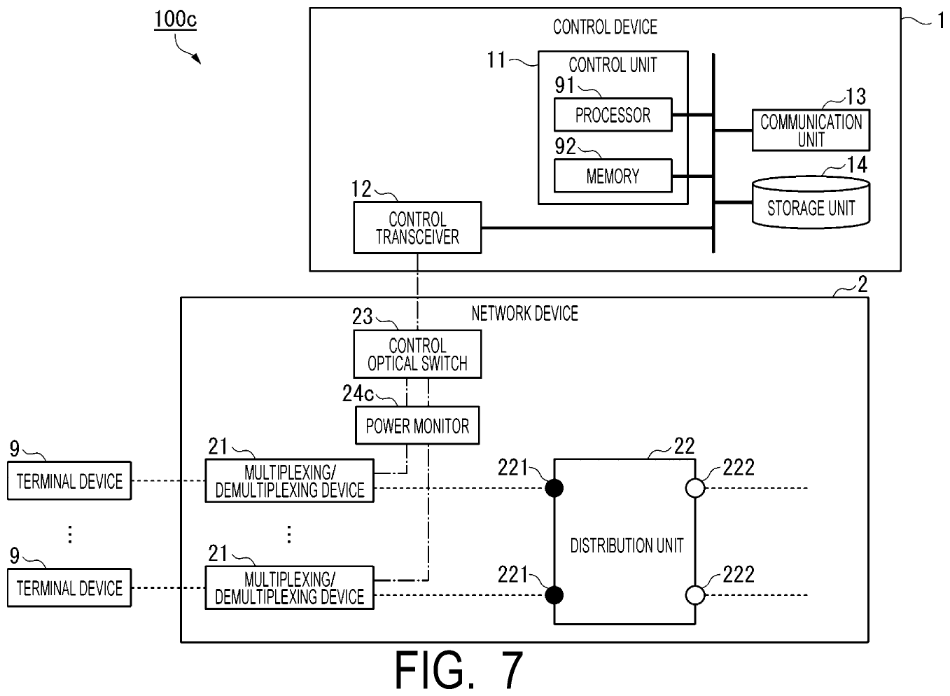

FIG. 7 is a diagram illustrating a third example of a configuration of the control system 100 including a power monitor according to the modification. FIG. 7 illustrates a control system 100c as an example of the control system 100 including a power monitor according to the modification.

The control system 100c is different from the control system 100 in including a power monitor 24c. The power monitor 24c measures the strength of the signal in the band of the control signal in each path regarding a path from at least the multiplexing/demultiplexing device 21, which is not a connection destination of the control transceiver 12, to the control optical switch 23 among paths from the multiplexing/demultiplexing devices 21 to the control optical switch 23.

Hereinafter, among the paths from the multiplexing/demultiplexing devices 21 to the control optical switch 23, the path from at least the multiplexing/demultiplexing device 21, which is not a connection destination of the control transceiver 12, to the control optical switch 23 is referred to as a second measured path.

The power monitor 24c may measure the strength at any location as long as the strength of the signal in the band of the control signal in each path, which is the second measured path, can be measured. Accordingly, for example, the power monitor 24c measures the strength at a location between the multiplexing/demultiplexing device 21 and the control optical switch 23.

The power monitor 24c transmits the measurement result to the control unit 11. The measurement by the power monitor 24c is performed at a predetermined timing such as periodically. Specifically, the measurement result is information indicating the measured strength in each path.

The control unit 11 that has received the measurement result determines whether there is a path (hereinafter referred to as a “second target path”) the strength of which indicated by the measurement result of the power monitor 24c is equal to or higher than a predetermined strength. Here, the predetermined strength is a strength with which the control unit 11 can determine whether the power monitor 24c has measured the strength of the control signal. When there is a second target path, the control unit 11 executes switching processing of switching the connection destination of the control transceiver 12 to the multiplexing/demultiplexing device 21 through which the control signal propagating through the second target path has passed.

As described above, in the control system 100c, the control unit 11 executes the switching processing of switching the connection destination of the control transceiver 12 by controlling the operation of the control optical switch 23 on the basis of the measurement result of the power monitor 24c.

Note that the power monitor 24c includes, for example, a probe including a power splitter, and measures the strength by separating a part of the optical signal propagating on the path using the power splitter and receiving the separated signal.

In addition, the power monitor 24c may include a light-receiving unit for each measurement target path and measure the strength in each path, or may include one light-receiving unit and periodically change the location of the probe to sequentially measure the strength in each path.

To be sure, an example of determination of a path (that is, a candidate for the second target path) through which the optical signal having passed through the multiplexing/demultiplexing device 21 that is not a connection destination of the control transceiver 12 propagates will be described. The determination of the candidate for the second target path is performed by the control unit 11 on the basis of the connection destination information, for example. A path other than the path connected to the connection destination indicated by the connection destination information is a candidate for the second target path.

<<Regarding Effects Achieved by Including Power Monitor 24c>>

In general, the terminal device 9 does not stop the transmission only once transmitting the control signal, but then transmits the optical signal many times in succession. Therefore, when the control unit 11 determines that the path is the second target path, it means that the control signal has propagated to the second target path, and therefore, there is a high possibility that the optical signal is transmitted to the second target path thereafter from the terminal device 9, which is a transmission source that has transmitted the control signal.

Accordingly, it is desirable from the viewpoint of communication efficiency that the control unit 11 starts communication with the terminal device 9 that is the transmission source of the control signal propagated through the second target path. This is because when the terminal device 9 that transmits the control signal and the control unit 11 perform communication and the propagation destination of the control signal is not controlled, communication with many erroneous transmissions occurs.

Switching of the connection destination of the control transceiver 12 may be performed, for example, by a method that is performed periodically without using the power monitor 24c, but in this case, it may take time to find the terminal device 9 that transmits the control signal. On the other hand, when the power monitor 24c is used, the multiplexing/demultiplexing device 21 connected to the terminal device 9 that transmits the control signal can be a connection destination of the control transceiver 12 without setting the multiplexing/demultiplexing device 21 connected to the terminal device 9 that does not transmit the control signal to be a connection destination.

Therefore, since the control system 100c of the modification configured as described above includes the power monitor 24c, the communication efficiency can be enhanced.

### Fourth Example of Control System Including Power Monitor and Performing Switching Processing Based on Result of Measurement of Power Monitor

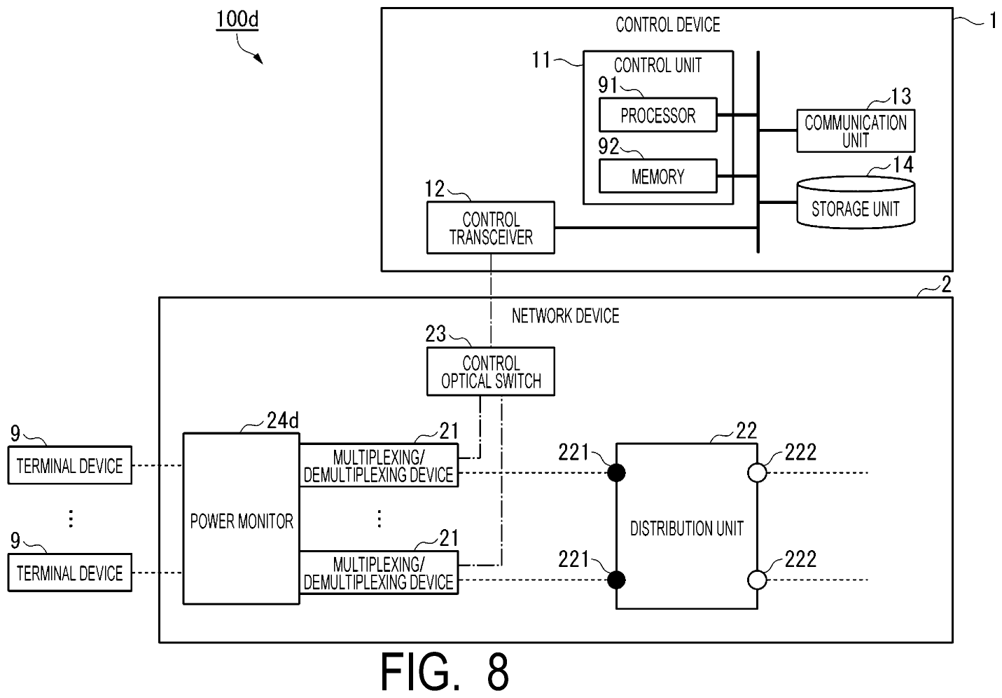

FIG. 8 is a diagram illustrating a fourth example of a configuration of the control system 100 including a power monitor according to the modification. FIG. 8 illustrates a control system 100d as an example of the control system 100 including a power monitor according to the modification.

The control system 100d is different from the control system 100 in including a power monitor 24d. The power monitor 24d measures the strength of an optical signal incident on at least the multiplexing/demultiplexing device 21 that is not a connection destination of the control transceiver 12.

The power monitor 24d may measure the strength at any location as long as it can measure the strength of the optical signal incident on the multiplexing/demultiplexing device 21. For example, the power monitor 24d may measure the strength of the input port of the multiplexing/demultiplexing device 21.

The power monitor 24d transmits the measurement result to the control unit 11. The measurement by the power monitor 24d is performed at a predetermined timing such as periodically. Specifically, the measurement result is information indicating the measured strength of the optical signal incident on each multiplexing/demultiplexing device 21.

The control unit 11 that has received the measurement result determines whether there is a multiplexing/demultiplexing device 21 (hereinafter referred to as a “target device”) the strength of which indicated by the measurement result of the power monitor 24d is equal to or higher than a predetermined strength. Here, the predetermined strength is a strength with which the control unit 11 can determine whether the power monitor 24d has measured the strength of the optical signal. When there is a target device, the control unit 11 executes switching processing of switching the connection destination of the control transceiver 12 to the target device.

As described above, in the control system 100d, the control unit 11 executes the switching processing of switching the connection destination of the control transceiver 12 by controlling the operation of the control optical switch 23 on the basis of the measurement result of the power monitor 24d.

Note that the power monitor 24d includes, for example, a probe including a power splitter, and measures the strength by separating a part of the optical signal using the power splitter and receiving the separated signal.

In addition, the power monitor 24d may include a light-receiving unit for each multiplexing/demultiplexing device 21, which is a measurement target, and measure the strength in each multiplexing/demultiplexing device, or may include one light-receiving unit and periodically change the location of the probe to sequentially measure the strength in each multiplexing/demultiplexing device.

To be sure, an example of determination of the multiplexing/demultiplexing device 21, which is not a connection destination of the control transceiver 12, will be described. Since the multiplexing/demultiplexing device 21, which is not a connection destination, is the multiplexing/demultiplexing device 21 other than the multiplexing/demultiplexing device 21 indicated by the connection destination information, the determination of the multiplexing/demultiplexing device 21, which is not a connection destination, is performed on the basis of the connection destination information by the control unit 11, for example. The multiplexing/demultiplexing device 21 indicated by the connection destination information is a candidate for the target device.

<<Regarding Effects Achieved by Including Power Monitor 24d>>

In general, the terminal device 9 does not stop the transmission only once transmitting the optical signal, but then transmits the optical signal many times in succession. Therefore, when the control unit 11 determines that the device is the target device, it means that the optical signal has propagated to the target device, and therefore, there is a high possibility that the optical signal is transmitted to the target device thereafter.

Accordingly, it is desirable from the viewpoint of communication efficiency that the control unit 11 starts communication with the terminal device 9 that is the transmission source of the optical signal propagated through the target device. This is because when the terminal device 9 that transmits the optical signal and the control unit 11 perform communication and the propagation destination of the optical signal is not controlled, communication with many erroneous transmissions occurs.

Switching of the connection destination of the control transceiver 12 may be performed, for example, by a method that is performed periodically without using the power monitor 24d, but in this case, it may take time to find the terminal device 9 that transmits the optical signal. On the other hand, when the power monitor 24d is used, the multiplexing/demultiplexing device 21 connected to the terminal device 9 that transmits the optical signal can be a connection destination of the control transceiver 12 without setting the multiplexing/demultiplexing device 21 connected to the terminal device 9 that does not transmit the optical signal to be a connection destination.

Therefore, since the control system 100d of the modification configured as described above includes the power monitor 24d, the communication efficiency can be enhanced.

### Example of Flow of Processing Executed in Control Systems 100a to 100d

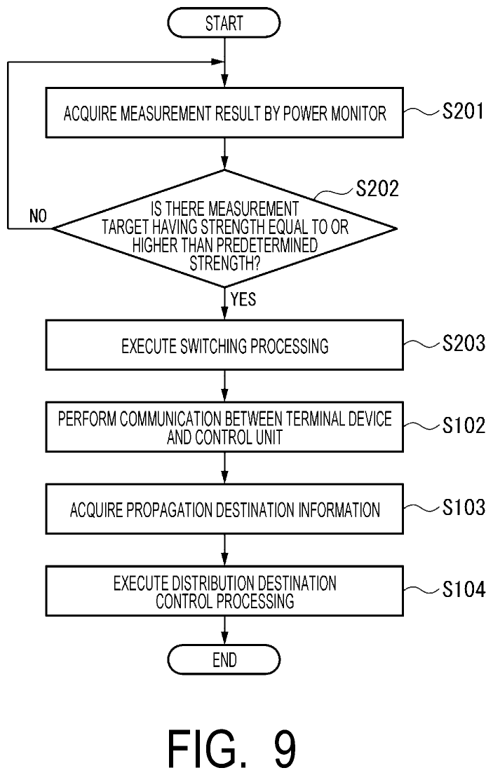

FIG. 9 is a flowchart illustrating an example of a flow of processing executed in each of the control systems 100a to 100d according to the modification. The control unit 11 acquires the measurement result measured by the power monitor (step S201). Note that the power monitor in step S101 is the power monitor 24a in the control system 100a and is the power monitor 24b in the control system 100b. Then, the power monitor in step S101 is the power monitor 24c in the control system 100c and is the power monitor 24d in the control system 100d.

Next, based on the strength indicated by the acquired measurement result, the control unit 11 determines whether there is a measurement target indicating a strength equal to or higher than a predetermined strength among measurement targets of the power monitor in step S101 (step S202). If there is no measurement target (step S202: NO), the processing returns to step S201. If there is a measurement target (step S202: YES), the control unit 11 executes the switching processing in which the multiplexing/demultiplexing device 21 connected to the transmission source of the optical signal having propagated through the measurement target indicating the strength equal to or higher than the predetermined strength is set as the connection destination of the control transceiver 12 (step S203). Note that, in a case where the measurement target is the multiplexing/demultiplexing device 21, the multiplexing/demultiplexing device 21 connected to the measurement target is the multiplexing/demultiplexing device 21 itself. After step S203, the processing in step S102 described above is executed, after step S102, the processing in step S103 described above is executed, and then the processing in step S104 described above is executed.

The control systems 100a to 100d of the modification configured as described above include a smaller number of control transceivers 12 than the number of terminal devices 9 in communication with the terminal devices 9 using optical signals. Therefore, it is possible to suppress an increase in size of the device required for optical communication. In addition, as described above, since the control systems 100a to 100d of the modification configured as described above include the power monitor, the communication efficiency can be enhanced.

Note that the distribution unit 22 is an example of a distribution circuit. Note that the power monitor 24a may be provided anywhere as long as it is provided in the control system 100a, and is provided in, for example, the control device 1 or the network device 2. Note that the power monitor 24b may be provided anywhere as long as it is provided in the control system 100b, and is provided in, for example, the control device 1 or the network device 2. Note that the power monitor 24c may be provided anywhere as long as it is provided in the control system 100c, and is provided in, for example, the control device 1 or the network device 2. Note that the power monitor 24d may be provided anywhere as long as it is provided in the control system 100d, and is provided in, for example, the control device 1 or the network device 2.

Note that the control of the distribution unit 22 by the control unit 11 may be performed via the communication unit 13, for example, or may be performed by communication via a bus in a case where the control unit 11 and the distribution unit 22 are connected by the bus. In addition, the transmission of the measurement results of the power monitors 24a to 24d to the control unit 11 may be performed, for example, via the communication unit 13, or may be performed by communication via a bus in a case where the control unit 11 and the power monitors 24a to 24d are connected by the bus.

Note that the control optical switch 23 and the distribution unit 22 do not necessarily need to be implemented as different devices, and may be implemented as one device having both functions.

Note that each of the control device 1 and the network device 2 may be implemented using a plurality of information processing devices communicably connected via a network. In this case, the functional units included in each of the control device 1 and the network device 2 may be implemented in a distributed manner in a plurality of information processing devices.

Note that the control device 1 and the network device 2 do not necessarily need to be implemented as different devices. The control device 1 and the network device 2 may be implemented as one device having both functions, for example.

Note that all or some of the functions of each of the control device 1 and the network device 2 may be achieved by using hardware such as an application specific integrated circuit (ASIC), a programmable logic device (PLD), or a field programmable gate array (FPGA). The program may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program may be transmitted via an electrical communication line.

Although the embodiment of this invention has been described in detail with reference to the drawings, specific configurations are not limited to the embodiment and include design and the like within the gist of this invention.

### REFERENCE SIGNS LIST

100 Control system
1 Control device
2 Network device
11 Control unit
12 Control transceiver
13 Communication unit
14 Storage unit
21 Multiplexing/demultiplexing device
22 Distribution unit
221 Input port
222 Output port
223 Initial connection port
23 Control optical switch
24a to 24d Power monitor
91 Processor
92 Memory
93 Processor
94 Memory
900 Storage unit
901 Control unit

1. A control system required for optical communication, the control system comprising:
a processor;
a storage medium having computer program instructions stored thereon, wherein the computer program instruction, when executed by the processor, perform processing of:
performing communication using an optical signal with a plurality of terminal equipments that is external equipments that transmit a control signal that is an optical signal for controlling an operation of the control system and a non-control signal that is an optical signal that is not the control signal;
a wave division multiplexer that is provided for each of the terminal equipments and demultiplexes a signal in a band of the control signal and a signal in a band of the non-control signal;
a control transceiver that is connected to any one of the wave division multiplexers and performs conversion between an optical signal and an electric signal;
a control optical switch that switches the wave division multiplexer that is a connection destination of the control transceiver;
a distribution circuit that includes one or a plurality of input ports on which an optical signal is incident and one or a plurality of output ports from which the optical signal incident on the input port is output and is capable of changing a correspondence relationship between the input ports and the output ports; and
a power monitor that measures a strength of the optical signal, wherein
the control signal is a signal transmitted and received between the terminal equipment and the processor, and is a signal for one to control an other,
the control transceiver converts the signal in the band of the control signal demultiplexed by the wave division multiplexer that is a connection destination to an electric signal,
the processor executes processing of: communicating with the terminal equipment based on information indicated by the electric signal, acquiring propagation destination information indicating a propagation destination of a non-control signal, controlling the distribution circuit so that a non-control signal propagates to the propagation destination indicated by the propagation destination information, and switching a connection destination of the control transceiver by controlling an operation of the control optical switch based on a measurement result of the power monitor, and
a number of the control optical switches is smaller than a number of the terminal equipments.

2. The control system according to claim 1, wherein
a degree of overlap between the band of the control signal and the band of the non-control signal is equal to or less than a predetermined degree.

3. The control system according to claim 1, wherein
the power monitor measures a strength of the signal in the band of the non-control signal.

4. The control system according to claim 1, wherein
the power monitor measures a strength of the signal in the band of the control signal.

5. The control system according to claim 1, wherein
the wave division multiplexer measures a strength of an optical signal incident on the wave division multiplexer.

6. A control device comprising:
a processor;
a storage medium having computer program instructions stored thereon, wherein the computer program instruction, when executed by the processor, perform processing of:
performing communication using an optical signal with a plurality of terminal equipments that is external equipments that transmit a control signal that is an optical signal for controlling an operation of a control system required for optical communication and a non-control signal that is an optical signal that is not the control signal; and
a control transceiver that is connected to any one of wave division multiplexers that are provided for each of the terminal equipments and demultiplex a signal in a band of the control signal and a signal in a band of the non-control signal, and performs conversion between an optical signal and an electric signal, wherein
the processor controls an operation of a network equipment including the wave division multiplexer, a control optical switch that switches the wave division multiplexer that is a connection destination of the control transceiver, a distribution circuit that includes one or a plurality of input ports on which an optical signal is incident and one or a plurality of output ports from which the optical signal incident on the input port is output and is capable of changing a correspondence relationship between the input ports and the output ports, and a power monitor that measures a strength of the optical signal,
the control signal is a signal transmitted and received between the terminal equipment and processor, and is a signal for one to control an other,
the control transceiver converts the signal in the band of the control signal demultiplexed by the wave division multiplexer that is a connection destination to an electric signal,
the processor executes processing of: communicating with the terminal equipment based on information indicated by the electric signal, acquiring propagation destination information indicating a propagation destination of a non-control signal, controlling the distribution circuit so that a non-control signal propagates to the propagation destination indicated by the propagation destination information, and switching a connection destination of the control transceiver by controlling an operation of the control optical switch based on a measurement result of the power monitor, and
a number of the control optical switches is smaller than a number of the terminal equipments.

7. A network equipment comprising:
a wave division multiplexer that is provided for each of a plurality of terminal equipments that is external equipments that transmit a control signal that is an optical signal for controlling an operation of a control system required for optical communication and a non-control signal that is an optical signal that is not the control signal and demultiplexes a signal in a band of the control signal and a signal in a band of the non-control signal;
a control optical switch that switches the wave division multiplexer that is a connection destination of the control transceiver included in a control equipment including: a processor; a storage medium having computer program instructions stored thereon, wherein the computer program instruction, when executed by the processor, perform processing of: performing communication using an optical signal with a plurality of the terminal equipments and the control transceiver that is connected to any one of the wave division multiplexers and performs conversion between an optical signal and an electric signal;
a distribution circuit that includes one or a plurality of input ports on which an optical signal is incident and one or a plurality of output ports from which the optical signal incident on the input port is output and is capable of changing a correspondence relationship between the input ports and the output ports; and
a power monitor that measures a strength of the optical signal, wherein
the control signal is a signal transmitted and received between the terminal equipment and the processor, and is a signal for one to control an other,
the control transceiver converts the signal in the band of the control signal demultiplexed by the wave division multiplexer that is a connection destination to an electric signal,
the processor executes processing of: communicating with the terminal equipment based on information indicated by the electric signal, acquiring propagation destination information indicating a propagation destination of a non-control signal, controlling the distribution circuit so that a non-control signal propagates to the propagation destination indicated by the propagation destination information, and switching a connection destination of the control transceiver by controlling an operation of the control optical switch based on a measurement result of the power monitor, and
a number of the control optical switches is smaller than a number of the terminal equipments.

8. (canceled)

9. (canceled)
